(19) United States
(12) Patent Application Publication
(10) Pub. No.: US 2026/0089743 A1
(43) Pub. Date: Mar. 26, 2026

(54) SIDELINK UNLICENSED SIDELINK SYNCHRONIZATION SIGNAL BLOCK PATTERN FOR DATA MULTIPLEXING

(71) Applicant: QUALCOMM Incorporated, San Diego, CA (US)

(72) Inventors: Chih-Hao LIU, San Diego, CA (US); Jing SUN, San Diego, CA (US); Xiaoxia ZHANG, San Diego, CA (US); Giovanni CHISCI, San Diego, CA (US); Stelios STEFANATOS, San Diego, CA (US)

(21) Appl. No.: 19/110,582

(22) PCT Filed: Oct. 4, 2023
(86) PCT No.: PCT/US2023/075943

§ 371 Date: Mar. 11, 2025

(30) Foreign Application Priority Data
Nov. 2, 2022 (GR) 20220100885

(51) Int. Cl. H04W 72/25; H04L 27/26; H04W 72/044

(52) U.S. Cl. CPC H04W 72/25; H04L 27/261; H04W 72/044

(57) ABSTRACT

Various aspects of the present disclosure generally relate to wireless communication. In some aspects, a first user equipment (UE) may transmit, to a second UE, a sidelink primary synchronization signal (S-PSS) using two S-PSS symbols in a sidelink synchronization signal block (S-SSB) slot, the S-SSB slot being associated with a sidelink unlicensed (SL-U) S-SSB pattern for data multiplexing, and the S-SSB slot being associated with a wideband physical sidelink broadcast channel (PSBCH). The first UE may transmit, to the second UE, a sidelink secondary synchronization signal (S-SSS) using two S-SSS symbols in the S-SSB slot, the S-SSB slot including four contiguous symbols that include the two S-PSS symbols and the two S-SSS symbols. Numerous other aspects are described.

### CROSS-REFERENCE TO RELATED APPLICATION

This Patent Application claims priority to Greek Patent Application No. 20220100885, filed on Nov. 2, 2022, entitled “SIDELINK UNLICENSED SIDELINK SYNCHRONIZATION SIGNAL BLOCK PATTERN FOR DATA MULTIPLEXING,” which is hereby expressly incorporated by reference herein.

### FIELD OF THE DISCLOSURE

Aspects of the present disclosure generally relate to wireless communication and to techniques and apparatuses for a sidelink unlicensed (SL-U) sidelink synchronization signal block (S-SSB) pattern for data multiplexing.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to an apparatus for wireless communications at a first user equipment (UE). The apparatus may include a memory and one or more processors coupled to the memory. The one or more processors may be configured to transmit, to a second UE, a sidelink primary synchronization signal (S-PSS) using two S-PSS symbols in a sidelink synchronization signal block (S-SSB) slot, the S-SSB slot being associated with a sidelink unlicensed (SL-U) S-SSB pattern for data multiplexing, and the S-SSB slot being associated with a wideband physical sidelink broadcast channel (PSBCH). The one or more processors may be configured to transmit, to the second UE, a sidelink secondary synchronization signal (S-SSS) using two S-SSS symbols in the S-SSB slot, the S-SSB slot including four contiguous symbols that include the two S-PSS symbols and the two S-SSS symbols.

Some aspects described herein relate to an apparatus for wireless communications at a second UE. The apparatus may include a memory and one or more processors coupled to the memory. The one or more processors may be configured to receive, from a first UE, an S-PSS using two S-PSS symbols in an S-SSB slot, the S-SSB slot being associated with an SL-U S-SSB pattern for data multiplexing, and the S-SSB slot being associated with a wideband PSBCH. The one or more processors may be configured to receive, from the first UE, an S-SSS using two S-SSS symbols in the S-SSB slot, the S-SSB slot including four contiguous symbols that include the two S-PSS symbols and the two S-SSS symbols.

Some aspects described herein relate to a method of wireless communication performed by an apparatus of a first UE. The method may include transmitting, to a second UE, an S-PSS using two S-PSS symbols in an S-SSB slot, the S-SSB slot being associated with an SL-U S-SSB pattern for data multiplexing, and the S-SSB slot being associated with a wideband PSBCH. The method may include transmitting, to the second UE, an S-SSS using two S-SSS symbols in the S-SSB slot, the S-SSB slot including four contiguous symbols that include the two S-PSS symbols and the two S-SSS symbols.

Some aspects described herein relate to a method of wireless communication performed by an apparatus of a second UE. The method may include receiving, from a first UE, an S-PSS using two S-PSS symbols in an S-SSB slot, the S-SSB slot being associated with an SL-U S-SSB pattern for data multiplexing, and the S-SSB slot being associated with a wideband PSBCH. The method may include receiving, from the first UE, an S-SSS using two S-SSS symbols in the S-SSB slot, the S-SSB slot including four contiguous symbols that include the two S-PSS symbols and the two S-SSS symbols.

Some aspects described herein relate to a non-transitory computer-readable medium that stores a set of instructions for wireless communication by a first UE. The set of instructions, when executed by one or more processors of the first UE, may cause the first UE to transmit, to a second UE, an S-PSS using two S-PSS symbols in an S-SSB slot, the S-SSB slot being associated with an SL-U S-SSB pattern for data multiplexing, and the S-SSB slot being associated with a wideband PSBCH. The set of instructions, when executed by one or more processors of the first UE, may cause the first UE to transmit, to the second UE, an S-SSS using two S-SSS symbols in the S-SSB slot, the S-SSB slot including four contiguous symbols that include the two S-PSS symbols and the two S-SSS symbols.

Some aspects described herein relate to a non-transitory computer-readable medium that stores a set of instructions for wireless communication by a second UE. The set of instructions, when executed by one or more processors of the second UE, may cause the second UE to receive, from a first UE, an S-PSS using two S-PSS symbols in an S-SSB slot, the S-SSB slot being associated with an SL-U S-SSB pattern for data multiplexing, and the S-SSB slot being associated with a wideband PSBCH. The set of instructions, when executed by one or more processors of the second UE, may cause the second UE to receive, from the first UE, an S-SSS using two S-SSS symbols in the S-SSB slot, the S-SSB slot including four contiguous symbols that include the two S-PSS symbols and the two S-SSS symbols.

Some aspects described herein relate to a first apparatus for wireless communication. The first apparatus may include means for transmitting, to a second apparatus, an S-PSS using two S-PSS symbols in an S-SSB slot, the S-SSB slot being associated with an SL-U S-SSB pattern for data multiplexing, and the S-SSB slot being associated with a wideband PSBCH. The first apparatus may include means for transmitting, to the second apparatus, an S-SSS using two S-SSS symbols in the S-SSB slot, the S-SSB slot including four contiguous symbols that include the two S-PSS symbols and the two S-SSS symbols.

Some aspects described herein relate to a second apparatus for wireless communication. The second apparatus may include means for receiving, from a first apparatus, an S-PSS using two S-PSS symbols in an S-SSB slot, the S-SSB slot being associated with an SL-U S-SSB pattern for data multiplexing, and the S-SSB slot being associated with a wideband PSBCH. The second apparatus may include means for receiving, from the first apparatus, an S-SSS using two S-SSS symbols in the S-SSB slot, the S-SSB slot including four contiguous symbols that include the two S-PSS symbols and the two S-SSS symbols.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a sidelink synchronization signal block (S-SSB) structure, in accordance with the present disclosure.

FIG. 5 is a diagram illustrating an example of an S-SSB transmission, in accordance with the present disclosure.

FIG. 6 is a diagram illustrating an example of an S-SSB transmission, in accordance with the present disclosure.

FIG. 7 is a diagram illustrating an example of options for meeting occupied channel bandwidth (OCB) and power spectral density (PSD) requirements for S-SSB transmissions, in accordance with the present disclosure.

FIGS. 8-14 are diagrams illustrating examples associated with a sidelink unlicensed (SL-U) S-SSB pattern for data multiplexing, in accordance with the present disclosure.

FIGS. 15-16 are diagrams illustrating example processes associated with an SL-U S-SSB pattern for data multiplexing, in accordance with the present disclosure.

FIGS. 17-18 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

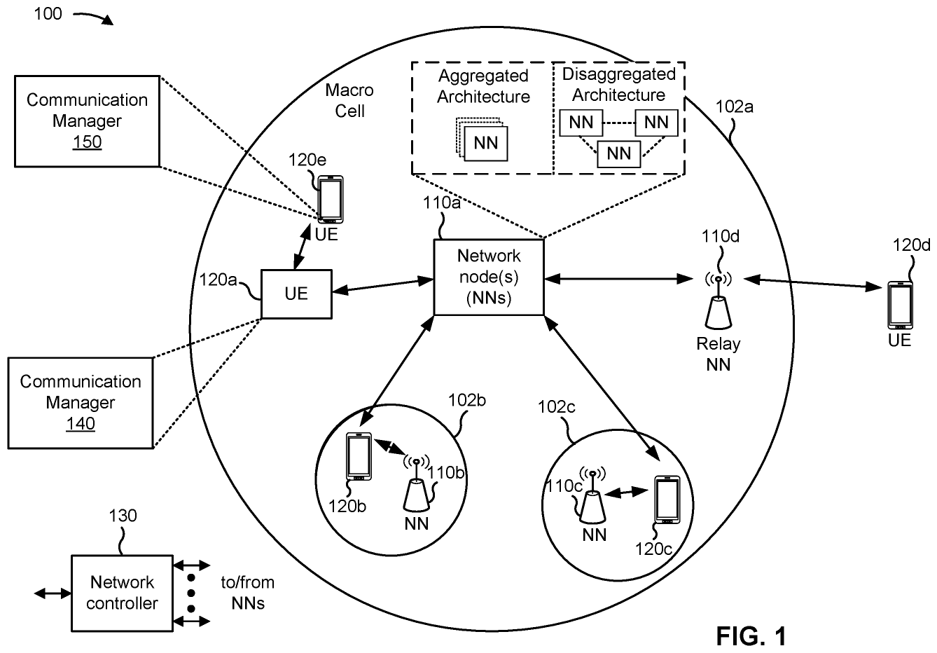

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHz). It should be understood that although a portion of FRI is greater than 6 GHZ, FRI is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FRI characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHZ), FR4 (52.6 GHz-114.25 GHZ), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a first UE (e.g., UE 120a) may include a communication manager 140. As described in more detail elsewhere herein, the communication manager 140 may transmit, to a second UE, a sidelink primary synchronization signal (S-PSS) using two S-PSS symbols in a sidelink synchronization signal block (S-SSB) slot, the S-SSB slot being associated with a sidelink unlicensed (SL-U) S-SSB pattern for data multiplexing, and the S-SSB slot being associated with a wideband physical sidelink broadcast channel (PSBCH); and transmit, to the second UE, a sidelink secondary synchronization signal (S-SSS) using two S-SSS symbols in the S-SSB slot, the S-SSB slot including four contiguous symbols that include the two S-PSS symbols and the two S-SSS symbols. Additionally, or alternatively, the communication manager 140 may perform one or more other operations described herein.

In some aspects, a second UE (e.g., UE 120e) may include a communication manager 150. As described in more detail elsewhere herein, the communication manager 150 may receive, from a first UE, an S-PSS using two S-PSS symbols in an S-SSB slot, the S-SSB slot being associated with an SL-U S-SSB pattern for data multiplexing, and the S-SSB slot being associated with a wideband PSBCH; and receive, from the first UE, an S-SSS using two S-SSS symbols in the S-SSB slot, the S-SSB slot including four contiguous symbols that include the two S-PSS symbols and the two S-SSS symbols. Additionally, or alternatively, the communication manager 150 may perform one or more other operations described herein.

As indicated above, FIG. 1 is provided as an example. Other examples may differ from what is described with regard to FIG. 1.

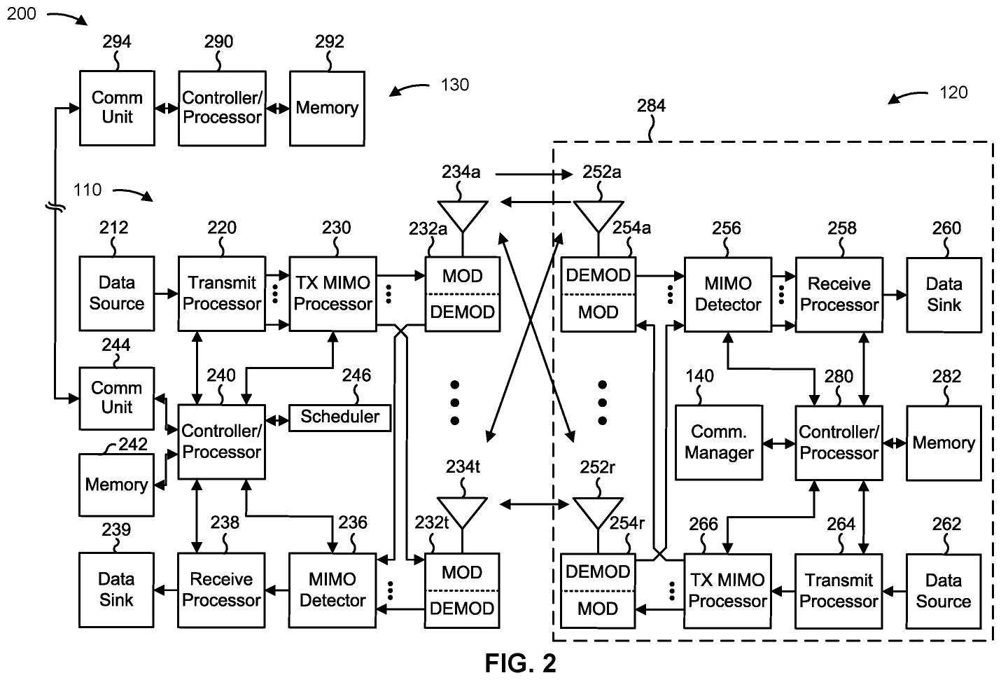

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., Toutput symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

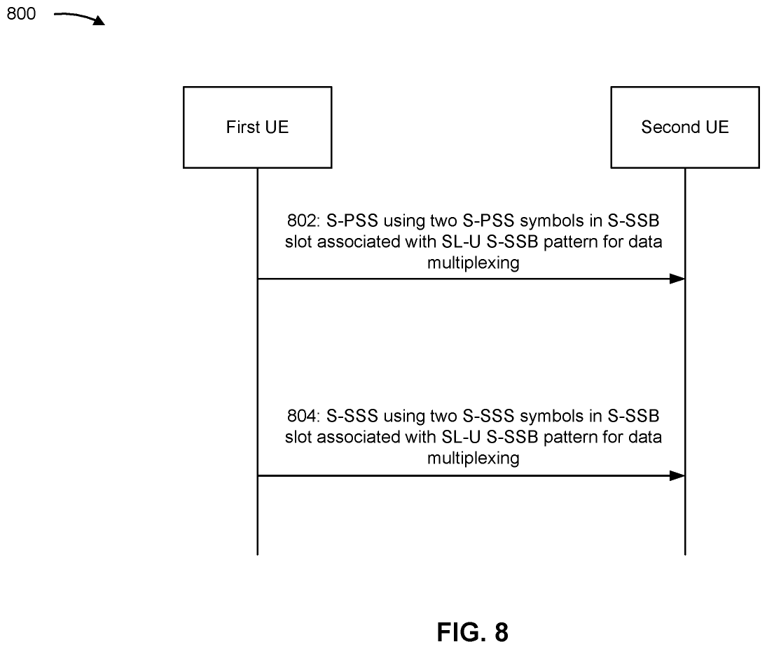

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 8-18).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 8-18).

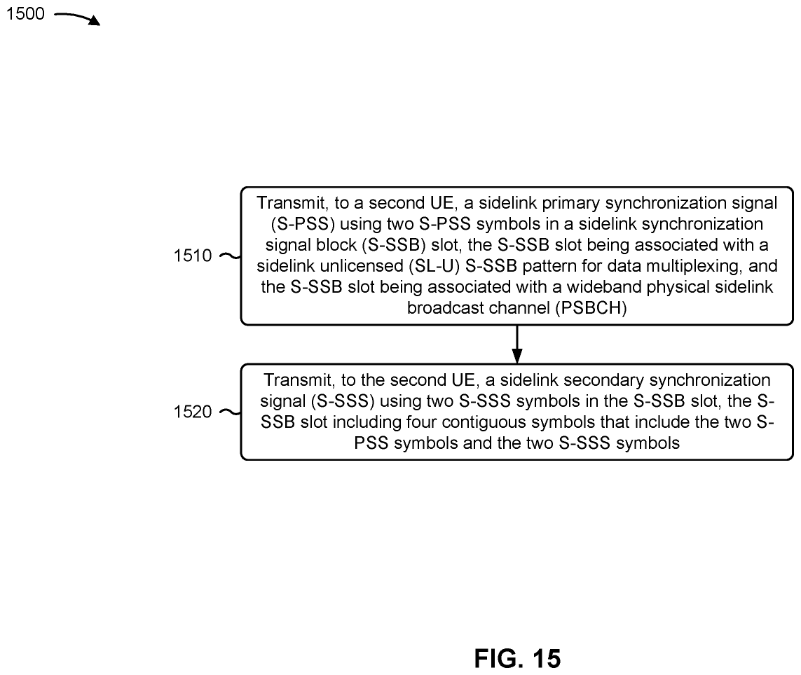

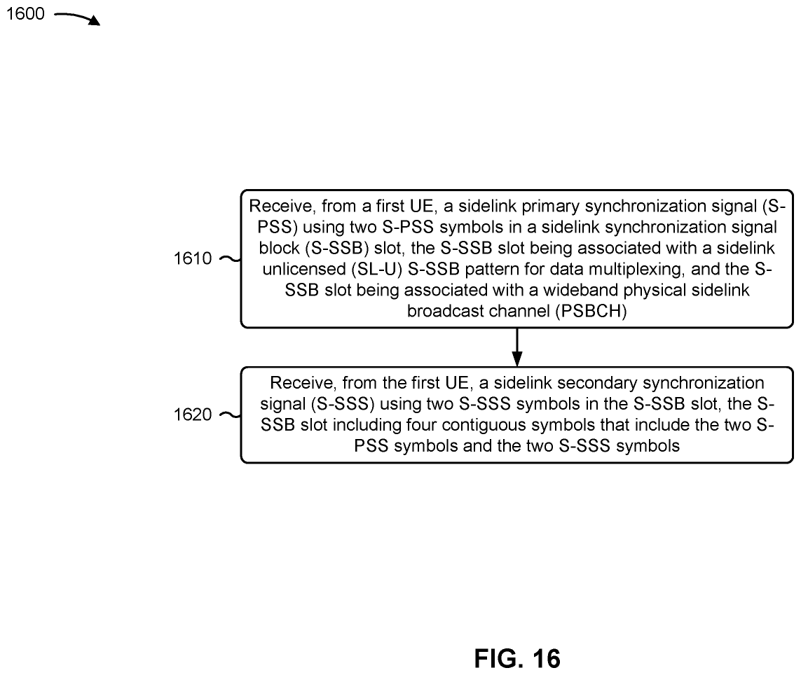

The controller/processor 240 of the network node 110, the controller/processor 280 of the UE 120, and/or any other component(s) of FIG. 2 may perform one or more techniques associated with an SL-U S-SSB pattern for data multiplexing, as described in more detail elsewhere herein. For example, the controller/processor 240 of the network node 110, the controller/processor 280 of the UE 120, and/or any other component(s) of FIG. 2 may perform or direct operations of, for example, process 1500 of FIG. 15, process 1600 of FIG. 16, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1500 of FIG. 15, process 1600 of FIG. 16, and/or other processes as described herein. In some examples, executing instructions may include running the instructions, converting the instructions, compiling the instructions, and/or interpreting the instructions, among other examples.

In some aspects, a first UE (e.g., UE 120a) includes means for transmitting, to a second UE, an S-PSS using two S-PSS symbols in an S-SSB slot, the S-SSB slot being associated with an SL-U S-SSB pattern for data multiplexing, and the S-SSB slot being associated with a wideband PSBCH; and/or means for transmitting, to the second UE, an S-SSS using two S-SSS symbols in the S-SSB slot, the S-SSB slot including four contiguous symbols that include the two S-PSS symbols and the two S-SSS symbols. In some aspects, the means for the first UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a second UE (e.g., UE 120e) includes means for receiving, from a first UE, an S-PSS using two S-PSS symbols in an S-SSB slot, the S-SSB slot being associated with an SL-U S-SSB pattern for data multiplexing, and the S-SSB slot being associated with a wideband PSBCH; and/or means for receiving, from the first UE, an S-SSS using two S-SSS symbols in the S-SSB slot, the S-SSB slot including four contiguous symbols that include the two S-PSS symbols and the two S-SSS symbols. In some aspects, the means for the second UE to perform operations described herein may include, for example, one or more of communication manager 150, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

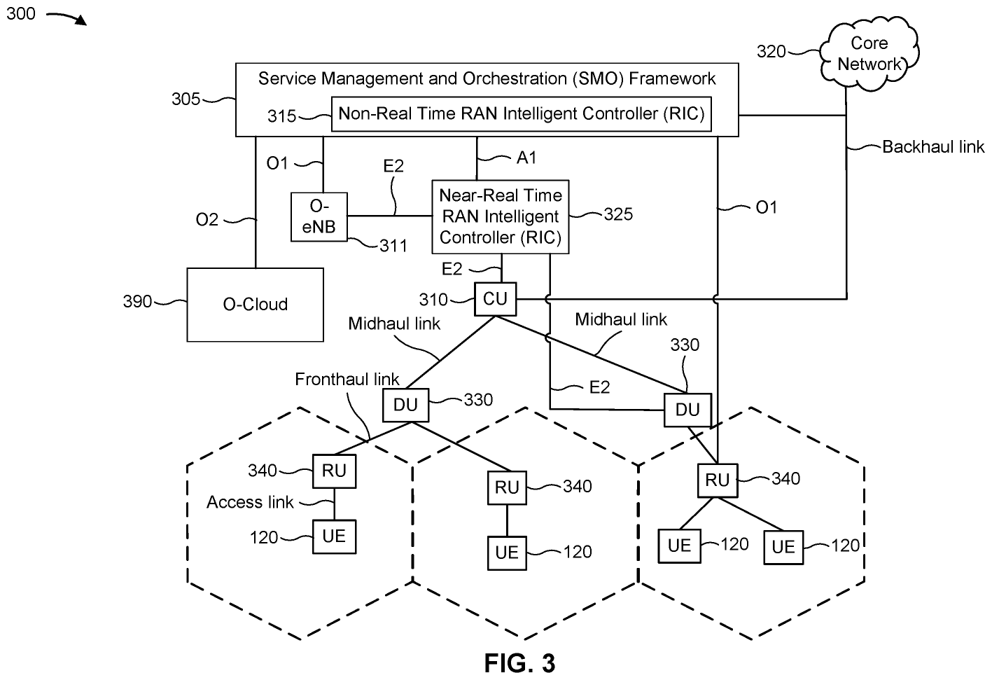

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the El interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an Ol interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an Ol interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as Al interface policies).

As indicated above, FIG. 3 is provided as an example. Other examples may differ from what is described with regard to FIG. 3.

NR Unlicensed (NR-U) may reuse an NR synchronization signal block (SSB) structure and location. An NR-U SSB structure may have additional SSB candidate positions as compared to the NR SSB structure. An SSB may be transmitted together with a channel state information reference signal (CSI-RS), a remaining minimum system information (RMSI) physical downlink control channel (PDCCH), an RMSI physical downlink shared channel (PDSCH) and other non-unicast transmissions in order to satisfy an occupied channel bandwidth (OCB) requirement, which may necessitate that a transmission fill at least 80% of a 20 MHz bandwidth.

A sidelink synchronization signal block (S-SSB) structure may include 11 uniform resource blocks (RBs). The S-SSB structure may be associated with a full slot transmission (e.g., 14 symbols including a gap symbol). An S-SSB transmission may not satisfy the OCB requirement by itself. The S-SSB transmission may not be multiplexed with other signals as well, such as physical sidelink control channel (PSCCH) signals or physical sidelink shared channel (PSSCH) signals, as the 11 RB structure may not match a PSCCH and/or PSSCH resource pool structure.

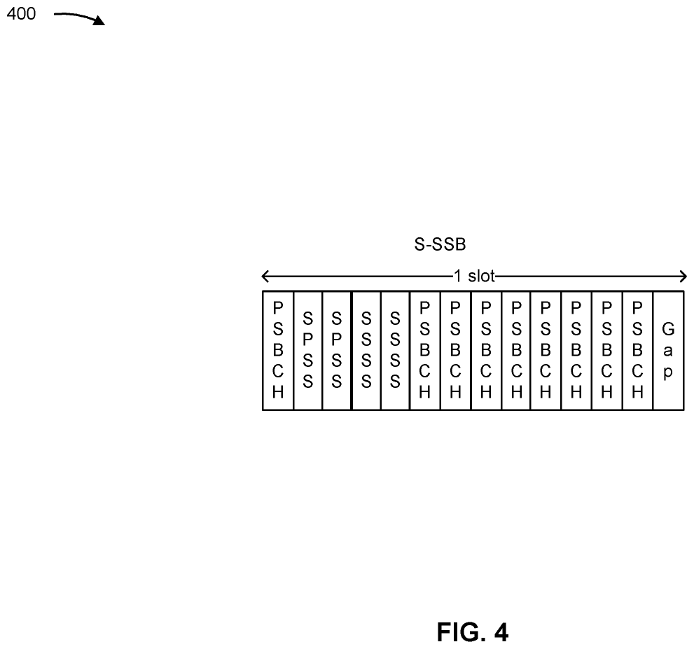

FIG. 4 is a diagram illustrating an example 400 of an S-SSB structure, in accordance with the present disclosure.

As shown in FIG. 4, the S-SSB structure may include 14 symbols. A first symbol may be associated with a physical sidelink broadcast channel (PSBCH). A second symbol and a third symbol may be associated with a sidelink primary synchronization signal (S-PSS). A fourth symbol and a fifth symbol may be associated with a sidelink secondary synchronization signal (S-SSS). Eight additional symbols may be associated with a PSBCH. A last symbol may be a gap symbol.

As indicated above, FIG. 4 is provided as an example. Other examples may differ from what is described with regard to FIG. 4.

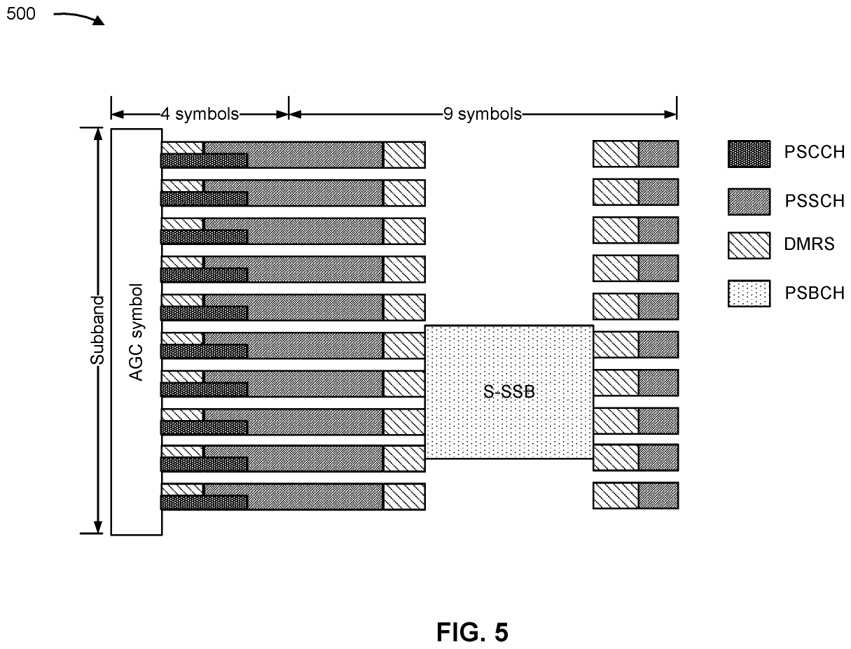

FIG. 5 is a diagram illustrating an example 500 of an S-SSB transmission, in accordance with the present disclosure.

As shown in FIG. 5, an NR S-SSB transmission may be multiplexed with a PSCCH and/or a PSSCH (PSCCH/PSSCH). A four-symbol S-SSB transmission may be multiplexed with a PSCCH/PSSCH to fulfill an OCB requirement. The four-symbol S-SSB transmission (e.g., from NR-U) may avoid a PSCCH and a DMRS rate matching. The four-symbol S-SSB transmission, for a 20 RB bandwidth, may satisfy at least a 2 MHz OCB when transmitted alone. A PSSCH transmission may rate match around S-SSB symbols. Further, PSSCH symbols may be power boosted and/or power de-boosted, such that a transmit power may be maintained to be the same across a plurality of symbols (e.g., all symbols).

As indicated above, FIG. 5 is provided as an example. Other examples may differ from what is described with regard to FIG. 5.

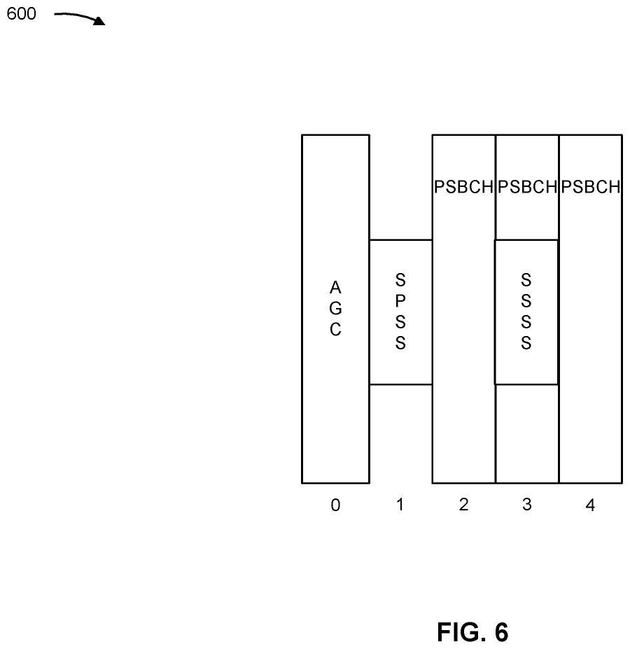

FIG. 6 is a diagram illustrating an example 600 of an S-SSB transmission, in accordance with the present disclosure.

As shown in FIG. 6, an NR S-SSB transmission may be multiplexed without a PSCCH/PSSCH. When an S-SSB transmitter has no data to multiplex, a temporary OCB may be allowed. A four-symbol S-SSB with an additional automatic gain control (AGC) symbol may be transmitted alone by fulfilling a temporary 20 MHz OCB constraint. The four-symbol S-SSB may include an S-PSS and an S-SSS. The four-symbol S-SSB may be associated with a PSBCH. During a channel occupancy time (COT), equipment may operate temporarily with an OCB of less than 80% of a nominal channel bandwidth with a minimum of 2 MHz. A type-1 listen-before-talk (LBT) may be considered as a baseline when the S-SSB transmission is transmitted alone. Further, the COT may be initiated for a temporary 2 MHz OCB.

As indicated above, FIG. 6 is provided as an example. Other examples may differ from what is described with regard to FIG. 6.

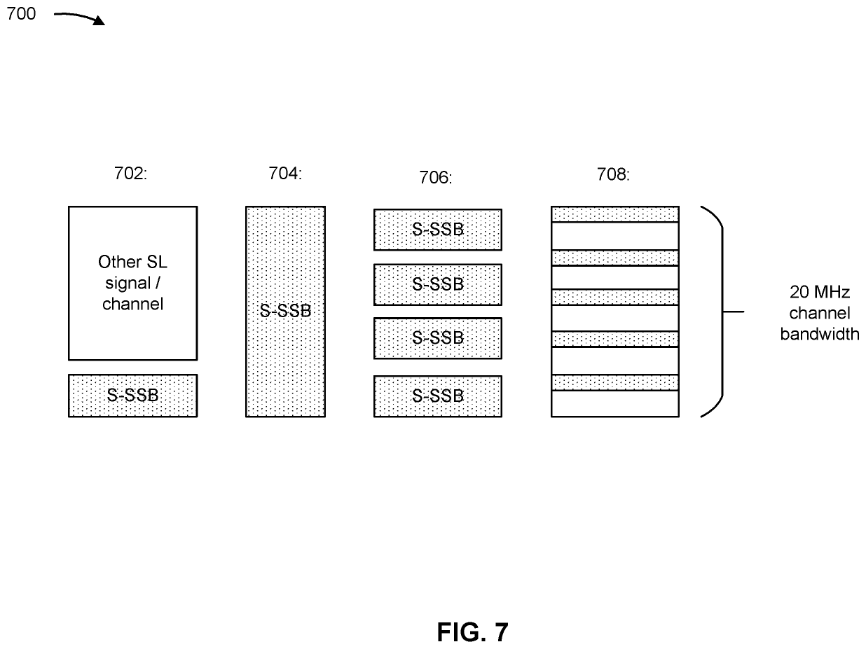

FIG. 7 is a diagram illustrating an example 700 of options for meeting OCB and power spectral density (PSD) requirements for S-SSB transmissions, in accordance with the present disclosure.

As shown by reference number 702, in a first option, an S-SSB transmission may be multiplexed with other sidelink transmissions in the same slot. As shown by reference number 704, in a second option, an S-SSB transmission (e.g., an S-PSS transmission, an S-SSS transmission, and/or a PSBCH transmission) may be associated with a wider bandwidth, as compared to other options for performing S-SSS transmissions. As shown by reference number 706, in a third option, an S-SSB transmission (e.g., an S-PSS transmission, an-S-SSS transmission, and/or a PSBCH transmission) may be associated with a repetition in a frequency domain. As shown by reference number 708, in a fourth option, interlaced RB transmissions may be used. Different options may be used to meet OCB and PSD requirements for S-SSB transmissions. Different options may be for a 20 MHz channel bandwidth. Further, a four-symbol S-SSB transmission may be supported.

The second option (e.g., S-PSS/S-SSS/PSBCH with wider bandwidth), the third option (e.g., repetition of S-PSS/S-SSS/PSBCH in frequency domain) and the fourth option (e.g., using interlaced RB transmissions) may be associated with an increased S-SSB bandwidth, which may be undesirable. The fourth option may be associated with a worse time-frequency synchronization performance, as compared to other options. The second option and the third option may be associated with searcher complexity (e.g., no narrowband searcher). The first option (e.g., S-SSB multiplexing with other sidelink transmissions in the same slot) may require S-SSB slots to be included in the resource pool, and a temporary 2 MHz exemption for standalone narrowband S-SSB may be associated with regulation uncertainty. Further, legacy S-SSB slots and new S-SSB slots may be included or excluded from data resource pools. For example, new S-SSB slots may be included in data resource pools, whereas legacy S-SSB slots may be kept outside of data resource pools.

As indicated above, FIG. 7 is provided as an example. Other examples may differ from what is described with regard to FIG. 7.

In various aspects of techniques and apparatuses described herein, a first UE may transmit, to a second UE, an S-PSS using two S-PSS symbols in an S-SSB slot. The S-SSB slot may be associated with an SL-U S-SSB pattern for data multiplexing. The S-SSB slot may be associated with a wideband PSBCH. The first UE may transmit, to the second UE, an S-SSS using two S-SSS symbols in the S-SSB slot. The S-SSB slot may include four contiguous symbols, which may include the two S-PSS symbols and the two S-SSS symbols. The four contiguous symbols may not overlap in a time domain and a frequency domain with a first four symbols of the S-SSB slot, based at least in part on the SL-U S-SSB pattern for data multiplexing. The four contiguous symbols may not overlap in the time domain and the frequency domain with a PSCCH of the S-SSB slot, based at least in part on the SL-U S-SSB pattern for data multiplexing. The four contiguous symbols may not overlap in the time domain and the frequency domain with DMRS symbols associated with a PSSCH of the S-SSB slot, based at least in part on the SL-U S-SSB pattern for data multiplexing. The four contiguous symbols may not overlap in the time domain and the frequency domain with sidelink control information part 2 (SCI-2), based at least in part on the SL-U S-SSB pattern for data multiplexing.

In some aspects, the SL-U S-SSB pattern for data multiplexing may incorporate the S-PSS and the S-SSS, which may be narrowband to enable a narrowband searcher in a narrowband receiver chain to be reused. The SL-U S-SSB pattern may be associated with the wideband PSBCH to fulfill an 80% OCB regulation. The SL-U S-SSB pattern may be associated with a consistent S-SSB waveform for legacy and S-SSB slots. The SL-U S-SSB pattern may be associated with the two S-PSS symbols and the two S-SSS symbols, which may allow for multiplexing with a PSCCH/PSSCH in new S-SSB slots. The SL-U S-SSB pattern may be associated with the wideband PSBCH to multiplex with the PSCCH/PSSCH. Further, in a new S-SSB slot, when a PSBCH takes an interlace waveform, other nodes may be able to select an interlace for PSCCH/PSSCH transmissions to avoid collisions with the wideband PSBCH.

FIG. 8 is a diagram illustrating an example 800 associated with an SL-U S-SSB pattern for data multiplexing, in accordance with the present disclosure. As shown in FIG. 8, example 800 includes communication between a first UE (e.g., UE 120a) and a second UE (e.g., UE 120e). In some aspects, the first UE and the second UE may be included in a wireless network, such as wireless network 100.

As shown by reference number 802, the first UE may transmit, to the second UE, an S-PSS using two S-PSS symbols in an S-SSB slot. The S-SSB slot may be associated with an SL-U S-SSB pattern for data multiplexing. The S-SSB slot may include an AGC symbol as the first symbol in the S-SSB slot. The S-SSB slot may include a gap symbol as the last symbol in the S-SSB slot. The S-SSB slot may include a PSCCH, a PSSCH (which may or may not be associated with DMRS symbols), and a PSBCH, such as a wideband PSBCH. The S-SSB slot may be associated with 14 symbols in a time domain, and the S-SSB slot may be associated with a quantity of subbands in a frequency domain.

As shown by reference number 804, the first UE may transmit, to the second UE, an S-SSS using two S-SSS symbols in the S-SSB slot. The S-SSB slot may include four contiguous symbols, which may include the two S-PSS symbols and the two S-SSS symbols. In some aspects, the four contiguous symbols may not overlap in the time domain and the frequency domain with a first four symbols of the S-SSB slot, based at least in part on the SL-U S-SSB pattern for data multiplexing. The four contiguous symbols may not overlap in the time domain and the frequency domain with a PSCCH of the S-SSB slot, based at least in part on the SL-U S-SSB pattern for data multiplexing. The four contiguous symbols may not overlap in the time domain and the frequency domain with DMRS symbols associated with a PSSCH of the S-SSB slot, based at least in part on the SL-U S-SSB pattern for data multiplexing. The four contiguous symbols may not overlap in the time domain and the frequency domain with SCI-2, based at least in part on the SL-U S-SSB pattern for data multiplexing. In some aspects, the S-SSB slot may be associated with a DMRS pattern having a four-symbol gap, a five-symbol gap, or a six-symbol gap between DMRSs to enable the four contiguous symbols to fit within the S-SSB slot.

In some aspects, the S-SSB slot may be associated with the wideband PSBCH. In some aspects, the wideband PSBCH may be an interlaced PSBCH across the S-SSB slot and rate matched around the two S-PSS symbols and the two S-SSS symbols. In some aspects, the wideband PSBCH may be a four-symbol interlaced PSBCH that is frequency division multiplexed with the two S-PSS symbols and the two S-SSS symbols. PSBCH interlaced RBs may be punctured or rate matched around S-PSS RBs and S-SSS RBs, and the PSBCH interlaced RBs may be at least a defined quantity of RBs from the S-PSS RBs and the S-SSS RBs. In some aspects, the wideband PSBCH may be an interlaced PSBCH across the S-SSB slot and rate matched around S-PSS resource elements (REs) and S-SSS REs. PSBCH interlaced RBs may be punctured or rate matched around S-PSS RBs and S-SSS RBs, and the PSBCH interlaced RBs may be at least a defined quantity of RBs from the S-PSS RBs and the S-SSS RBs. In some aspects, the wideband PSBCH may be a contiguous wideband four-symbol PSBCH that is frequency division multiplexed with the two S-PSS symbols and the two S-SSS symbols.

In some aspects, data associated with another UE may be multiplexed in the S-SSB slot based at least in part on a PSBCH interface that is not used for a PSCCH or PSSCH transmission across the S-SSB slot, or based at least in part on a time division multiplexing. In some aspects, a padding S-PSS or S-SSS with reserved sequences may be transmitted, an S-SSB transmission may be repeated, or the S-SSB transmission may be triggered to be repeated in the S-SSB slot within a COT to maintain a COT transmission across the four contiguous symbols in the S-SSB slot. In some aspects, the wideband PSBCH may be transmitted based at least in part on a fixed PSBCH interlace. In some aspects, the wideband PSBCH may be transmitted based at least in part on a PSBCH interlace index, where the PSBCH interlace index may be a function of a sidelink synchronization signal (SLSS) identifier (ID).

As indicated above, FIG. 8 is provided as an example. Other examples may differ from what is described with regard to FIG. 8.

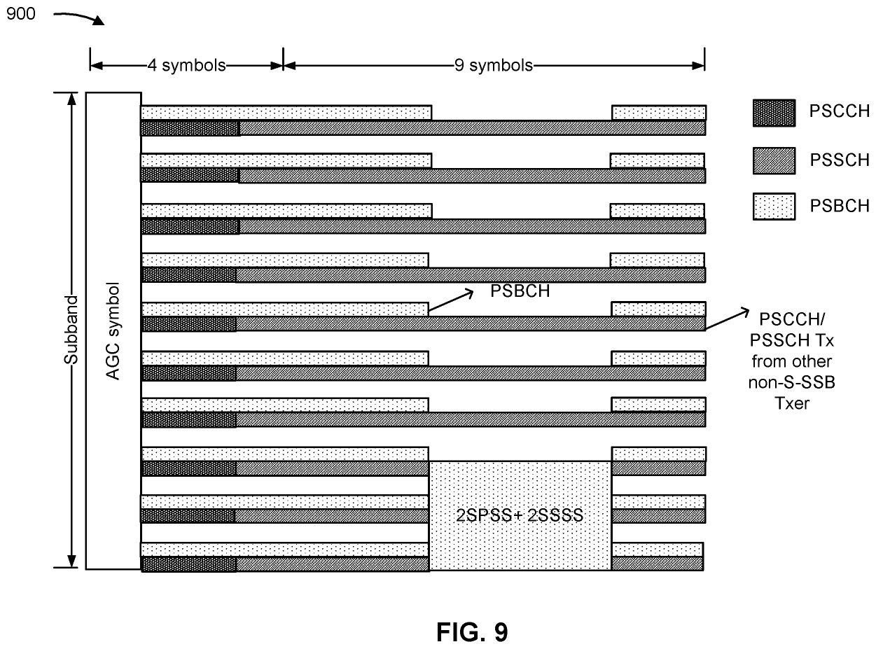

FIG. 9 is a diagram illustrating an example 900 associated with an SL-U S-SSB pattern for data multiplexing, in accordance with the present disclosure.

As shown in FIG. 9, an SL-U S-SSB pattern for data multiplexing may be defined for an S-SSB slot. The SL-U S-SSB pattern may include a first symbol for AGC. The SL-U S-SSB pattern may include two symbols, immediately after the first symbol, which may be associated with a PSCCH. A PSSCH may follow the PSCCH. The SL-U S-SSB pattern may employ four symbols for an S-PSS and an S-SSS. Two symbols out of the four symbols may be two S-PSS symbols. The other two symbols out of the four symbols may be two S-SSS symbols. The two S-PSS symbols (2XSPSS) and the two S-SSS symbols (2XSSSS) may be associated with 11 RBs. In some aspects, the SL-U S-SSB pattern may be associated with a wideband PSBCH. The wideband PSBCH may be an interlaced PSBCH across the S-SSB slot, and may be rate matched around the two S-PSS symbols and the two S-SSS symbols.

As indicated above, FIG. 9 is provided as an example. Other examples may differ from what is described with regard to FIG. 9.

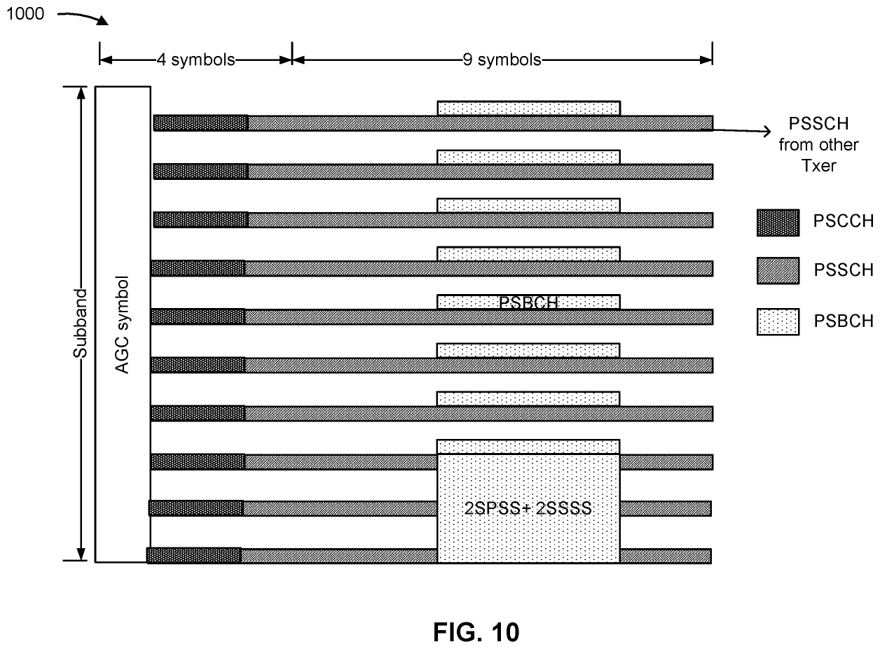

FIG. 10 is a diagram illustrating an example 1000 associated with an SL-U S-SSB pattern for data multiplexing, in accordance with the present disclosure.

As shown in FIG. 10, an SL-U S-SSB pattern for data multiplexing may be defined for an S-SSB slot. The SL-U S-SSB pattern may include a first symbol for AGC. The SL-U S-SSB pattern may include two symbols, immediately after the first symbol, which may be associated with a PSCCH. A PSSCH may follow the PSCCH. The PSSCH may include DMRS symbols. The SL-U S-SSB pattern may employ four symbols for an S-PSS and an S-SSS. Two symbols out of the four symbols may be two S-PSS symbols. The other two symbols out of the four symbols may be two S-SSS symbols. The two S-PSS symbols (2XSPSS) and the two S-SSS symbols (2XSSSS) may be associated with 11 RBs. In some aspects, the SL-U S-SSB pattern may be associated with a wideband PSBCH. The wideband PSBCH may be a four-symbol interlaced PSBCH, which may be frequency division multiplexed with the two S-PSS symbols and the two S-SSS symbols. The four-symbol interlaced PSBCH may be associated with an irregular waveform with a relatively high peak-to-average-power ratio (PAPR), and a four symbol, 10 RB PSBCH may have coverage issues.

As indicated above, FIG. 10 is provided as an example. Other examples may differ from what is described with regard to FIG. 10.

In some aspects, an SL-U S-SSB pattern for data multiplexing may employ an S-PSS and S-SSS pattern to allow data multiplexing. The SL-U S-SSB pattern may be defined for an S-SSB slot. The SL-U S-SSB pattern may employ four symbols for an S-PSS and an S-SSS. Two symbols out of the four symbols may be associated with the S-PSS. The other two symbols out of the four symbols may be associated with the S-SSS. The two symbols associated with the S-PSS (2XSPSS) and the two symbols associated with the S-SSS (2XSSSS) may be associated with 11 RBs. The four symbols for the S-PSS and the S-SSS (S-PSS/S-SSS) may avoid a PSCCH. The four symbols for the S-PSS/S-SSS may avoid DMRS symbols of a PSSCH. The four symbols for the S-PSS/S-SSS may avoid SCI-2.

In some aspects, four symbols for the S-PSS/S-SSS may avoid a first four symbols of the S-SSB slot, where a first symbol of the first four symbols may be an AGC symbol and up to three symbols of the first four symbols may be for the PSCCH. The four symbols for the S-PSS/S-SSS may avoid DMRS locations of the PSSCH. In a PSSCH DMRS pattern, a sufficient gap between DMRS locations may be identified to fit the four symbols for the S-PSS/S-SSS.

To avoid breaking another UE's PSSCH transmission into two parts, which may result in a PSSCH phase discontinuity, a new PSSCH DMRS pattern may be needed, such that the S-PSS/S-SSS may occupy a last 4 or 5 symbols. For example, for less than 11 PSSCH symbols, a legacy DMRS pattern may be reused, but for 11 or more 11 PSSCH symbols, a new DMRS pattern with {3,7} or {3,8} may need to be defined (e.g., “3”, “7”, or “8” may indicate a symbol number associated with a DMRS).

In some aspects, an additional AGC symbol before the four symbols for the S-PSS/S-SSS may be needed. A DMRS pattern that has a 4, 5, or 6 symbol gap between DMRSs may be selected so that the four symbols for the S-PSS/S-SSS are able to fit in between the DMRSs. Thus, only certain DMRS patterns may be used for S-SSB transmissions.

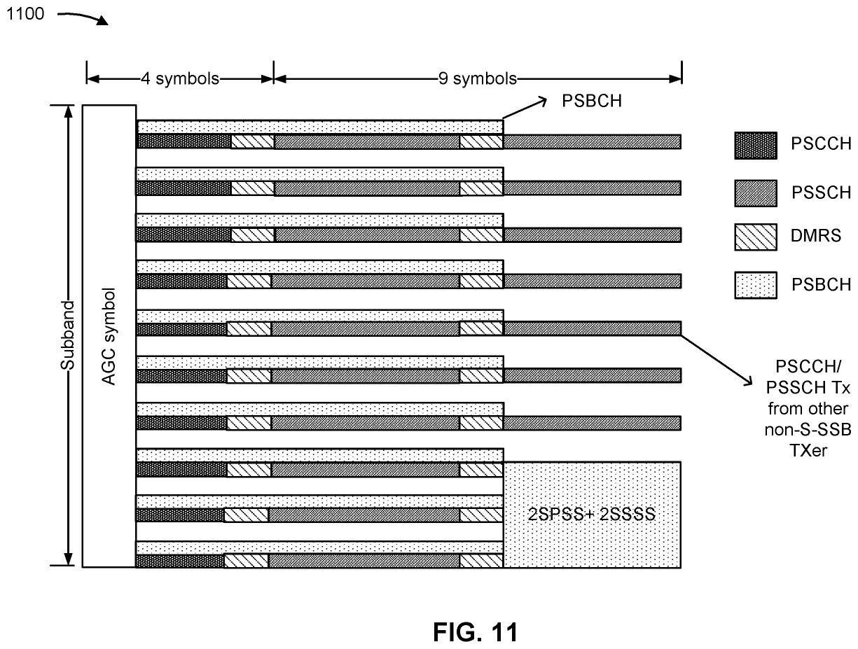

FIG. 11 is a diagram illustrating an example 1100 associated with an SL-U S-SSB pattern for data multiplexing, in accordance with the present disclosure.

As shown in FIG. 11, an SL-U S-SSB pattern for data multiplexing may be defined for an S-SSB slot. The SL-U S-SSB pattern may include a first symbol for AGC. The SL-U S-SSB pattern may include two symbols, immediately after the first symbol, which may be associated with a PSCCH. A PSSCH may follow the PSCCH. The PSSCH may include DMRS symbols. The SL-U S-SSB pattern may employ four symbols for an S-PSS and an S-SSS. The four symbols may be the last four symbols in the S-SSB slot. Two symbols out of the four symbols may be two S-PSS symbols. The other two symbols out of the four symbols may be two S-SSS symbols. The two S-PSS symbols (2XSPSS) and the two S-SSS symbols (2XSSSS) may be associated with 11 RBs. In some aspects, the SL-U S-SSB pattern may be associated with a wideband PSBCH. The wideband PSBCH may be an interlaced PSBCH across the S-SSB slot, and may be rate matched around the two S-PSS symbols and the two S-SSS symbols.

As indicated above, FIG. 11 is provided as an example. Other examples may differ from what is described with regard to FIG. 11.

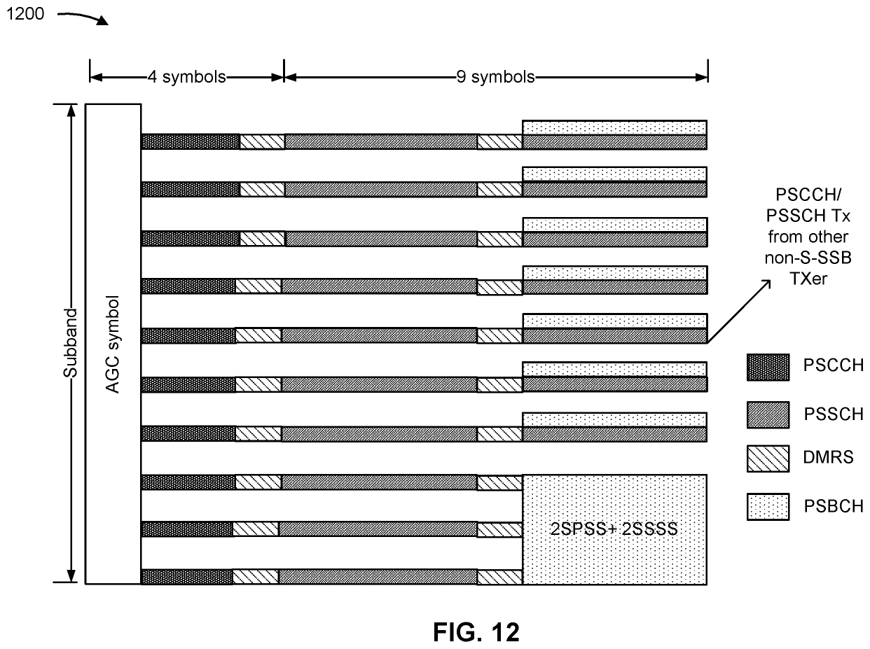

FIG. 12 is a diagram illustrating an example 1200 associated with an SL-U S-SSB pattern for data multiplexing, in accordance with the present disclosure.

As shown in FIG. 12, an SL-U S-SSB pattern for data multiplexing may be defined for an S-SSB slot. The SL-U S-SSB pattern may include a first symbol for AGC. The SL-U S-SSB pattern may include two symbols, immediately after the first symbol, which may be associated with a PSCCH. A PSSCH may follow the PSCCH. The PSSCH may include DMRS symbols. The SL-U S-SSB pattern may employ four symbols for an S-PSS and an S-SSS. The four symbols may be the last four symbols in the S-SSB slot. Two symbols out of the four symbols may be two S-PSS symbols. The other two symbols out of the four symbols may be two S-SSS symbols. The two S-PSS symbols (2XSPSS) and the two S-SSS symbols (2XSSSS) may be associated with 11 RBs.

In some aspects, the SL-U S-SSB pattern may be associated with a wideband PSBCH. In a second option, the wideband PSBCH may be a four-symbol or a five-symbol interlaced PSBCH, which may be frequency division multiplexed with the two S-PSS symbols and the two S-SSS symbols. The interlaced PSBCH may occupy the same symbols as a four-symbol or a five-symbol S-PSS/S-SSS. PSBCH interlaced RBs may be punctured, or rate matched around S-PSS/S-SSS RBs. The PSBCH interlaced RBs may be at least X RBs from the S-PSS/S-SSS RBs. With the X RBs spacing, the PSBCH interlaced RBs may not share the transmit power with S-PSS/S-SSS RBs under a PSD limit.

As indicated above, FIG. 12 is provided as an example. Other examples may differ from what is described with regard to FIG. 12.

In some aspects, an interlaced PSBCH may be across an S-SSB slot, and may rate match around S-PSS REs and S-SSS REs. PSBCH interlaced RBs may be punctured, or may be rate matched around S-PSS/S-SSS RBs. Further, the PSBCH interlaced RBs may be at least X RBs from the S-PSS/S-SSS RBs.

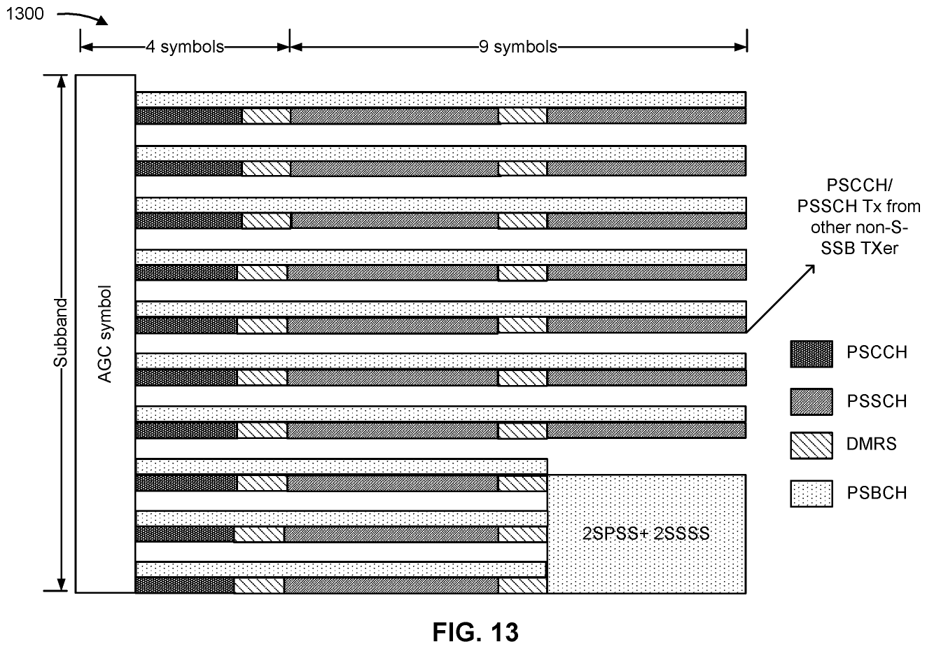

FIG. 13 is a diagram illustrating an example 1300 associated with an SL-U S-SSB pattern for data multiplexing, in accordance with the present disclosure.

As shown in FIG. 13, an SL-U S-SSB pattern for data multiplexing may be defined for an S-SSB slot. The SL-U S-SSB pattern may include a first symbol for AGC. The SL-U S-SSB pattern may include two symbols, immediately after the first symbol, which may be associated with a PSCCH. A PSSCH may follow the PSCCH. The PSSCH may include DMRS symbols. The SL-U S-SSB pattern may employ four symbols for an S-PSS and an S-SSS. The four symbols may be the last four symbols in the S-SSB slot. Two symbols out of the four symbols may be two S-PSS symbols. The other two symbols out of the four symbols may be two S-SSS symbols. The two S-PSS symbols (2XSPSS) and the two S-SSS symbols (2XSSSS) may be associated with 11 RBs. In some aspects, the SL-U S-SSB pattern may be associated with a wideband PSBCH. The wideband PSBCH may be an interlaced PSBCH, which may be across the S-SSB slot, and may rate match around S-PSS REs and S-SSS REs. PSBCH interlaced RBs may be punctured, or may be rate matched around S-PSS/S-SSS RBs. Further, the PSBCH interlaced RBs may be at least X RBs from the S-PSS/S-SSS RBs.

As indicated above, FIG. 13 is provided as an example. Other examples may differ from what is described with regard to FIG. 13.

In some aspects, a contiguous wideband four-symbol PSBCH may be frequency division multiplexed with S-PSS symbols and S-SSS symbols, which may avoid using irregular waveforms and avoid coverage problems (as in a second option). For a 30 KHz subcarrier spacing (SCS), 40 RBs and four symbols may be available. A wideband PSBCH may occupy contiguous RBs next to the S-PSS symbols and the S-SSS symbols, which may ensure that an entire bandwidth of an S-SSB slot fulfills an OCB requirement. An S-SSB transmission during the S-SSB slot may be time division multiplexed with another UE's PSSCH transmission.

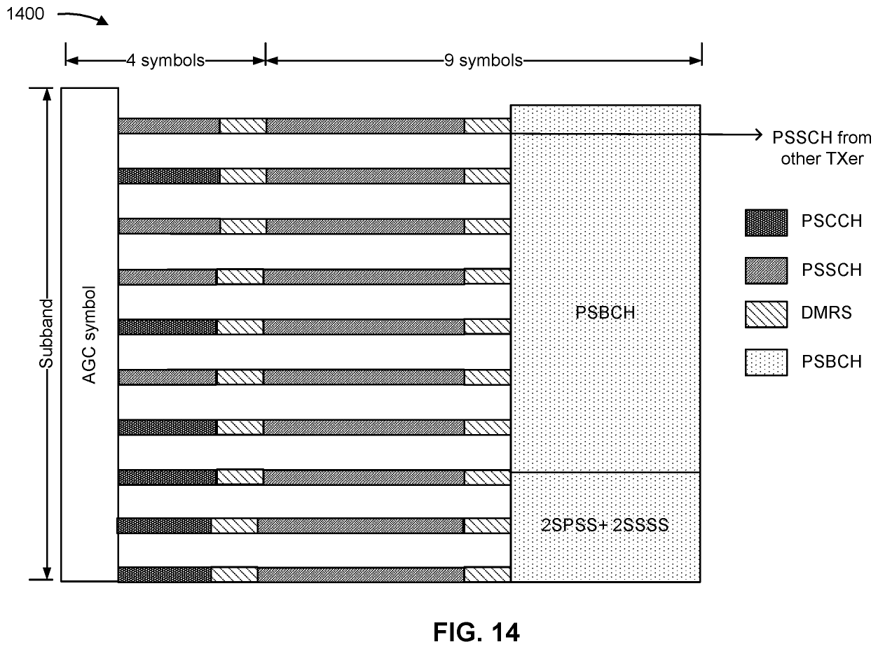

FIG. 14 is a diagram illustrating an example 1400 associated with an SL-U S-SSB pattern for data multiplexing, in accordance with the present disclosure.

As shown in FIG. 14, an SL-U S-SSB pattern for data multiplexing may be defined for an S-SSB slot. The SL-U S-SSB pattern may include a first symbol for AGC. The SL-U S-SSB pattern may include two symbols, immediately after the first symbol, which may be associated with a PSCCH. A PSSCH may follow the PSCCH. The PSSCH may include DMRS symbols. The SL-U S-SSB pattern may employ four symbols for an S-PSS and an S-SSS. The four symbols may be the last four symbols in the S-SSB slot. Two symbols out of the four symbols may be two S-PSS symbols. The other two symbols out of the four symbols may be two S-SSS symbols. The two S-PSS symbols (2XSPSS) and the two S-SSS symbols (2XSSSS) may be associated with 11 RBs. In some aspects, the SL-U S-SSB pattern may be associated with a wideband PSBCH. The wideband PSBCH may be a contiguous wideband four-symbol PSBCH, which may be frequency division multiplexed with the two S-PSS symbols and the two S-SSS symbols. The usage of the contiguous wideband four-symbol PSBCH may avoid using irregular waveforms and may avoid coverage problems. The wideband PSBCH may occupy contiguous RBs next to the two S-PSS symbols and the two S-SSS symbols, which may ensure that an entire bandwidth of an S-SSB slot fulfills an OCB requirement.

As indicated above, FIG. 14 is provided as an example. Other examples may differ from what is described with regard to FIG. 14.

In some aspects, a second UE (e.g., a non-S-SSB transmitter, a non-synchronization-reference (non-syncRef) node, or a second transmitter) may multiplex data in the same S-SSB slot based at least in part on a PSCCH/PSSCH multiplexing. In some aspects, when an interlaced PSBCH is across the S-SSB slot and rate matched around S-PSS/S-SSS symbols, or a 4/5 symbol interlaced PSBCH is frequency division multiplexed with S-PSS/S-SSS symbols, or an interlaced PSBCH is across the S-SSB slot and rate matched around S-PSS/S-SSS REs, the second UE may select an interlace other than a PSBCH interlace for a PSCCH/PSSCH transmission across the whole S-SSB slot. In S-PSS/S-SSS symbols, some PSSCH interlaced RBs may be punctured by the S-PSS/S-SSS, or a PSSCH may be rate matched around S-PSS/S-SSS resources. To keep a constant transmit power for the PSSCH across S-PSS/S-SSS symbols, power boosting may be used. In some aspects, when a contiguous wideband four-symbol PSBCH is frequency division multiplexed in S-PSS/S-SSS symbols, another S-SSB transmission may be time division multiplexed between the PSSCH and an S-SSB transmission from a first UE (e.g., an S-SSB transmitter, a syncRef node, or a first transmitter).

In some aspects, when a second UE (e.g., another data transmitter) has to maintain a COT across four S-SSB symbols in S-SSB slots in a resource pool, a padding signal may be transmitted. For the second UE to maintain its COT transmission across a potential four S-SSB symbols in the S-SSB slot, the second UE may transmit a padding S-PSS/S-SSS with reserved sequences, repeat its S-SSB, or trigger a first UE (e.g., a data transmitter) to repeat an S-SSB transmission in S-SSB slots within the COT. The second UE may transmit the padding S-PSS/S-SSS, or a repeated S-SSB may be transmitted, which may allow the first UE to maintain a phase continuity across S-SSB symbols in additional to avoiding a COT transmission gap.

In some aspects, when the first UE is not a syncRef node, the second UE may transmit a narrowband padding S-PSS/S-SSS in the S-SSB slot in the middle of its COT transmission. A 2 MHz temporary OCB rule may apply to the narrowband padding S-PSS/S-SSS. The narrowband padding S-PSS/S-SSS may be from reserved sequences not used to signal an SLSS ID, or may be mapped to some reserved SLSS ID. When the first UE is a syncRef node, the first UE may either transmit a repeated S-PSS/S-SSS only, or repeated S-SSBs in the S-SSB slots in the middle of its COT transmission. In some aspects, the first UE (or other syncRef node) may be triggered to repeat an S-SSB transmission in a COT transmission duration.

In some aspects, an interlaced PSBCH and a PSCCH/PSSCH may be frequency division multiplexed in a manner that avoids collisions. In some aspects, the first UE (e.g., a syncRef node) may select a fixed interlace to transmit the PSBCH, and second UEs (e.g., other data transmitting nodes) may detect the PSBCH by using blind decoding. Five or ten PSBCH interlace blind hypotheses may be needed. The second UEs may avoid PSBCH interlace(s) in S-SSB slots. In some aspects, a PSBCH interlace index may be a function of an SLSS ID. By detecting the SLSS ID from an S-PSS/S-SSS detection, the second UEs may be able to determine which interlace the first UE occupies, and the second UEs may avoid scheduling on that interlace.

FIG. 15 is a diagram illustrating an example process 1500 performed, for example, by a first UE, in accordance with the present disclosure. Example process 1500 is an example where the first UE (e.g., first UE 120a) performs operations associated with an SL-U S-SSB pattern for data multiplexing.

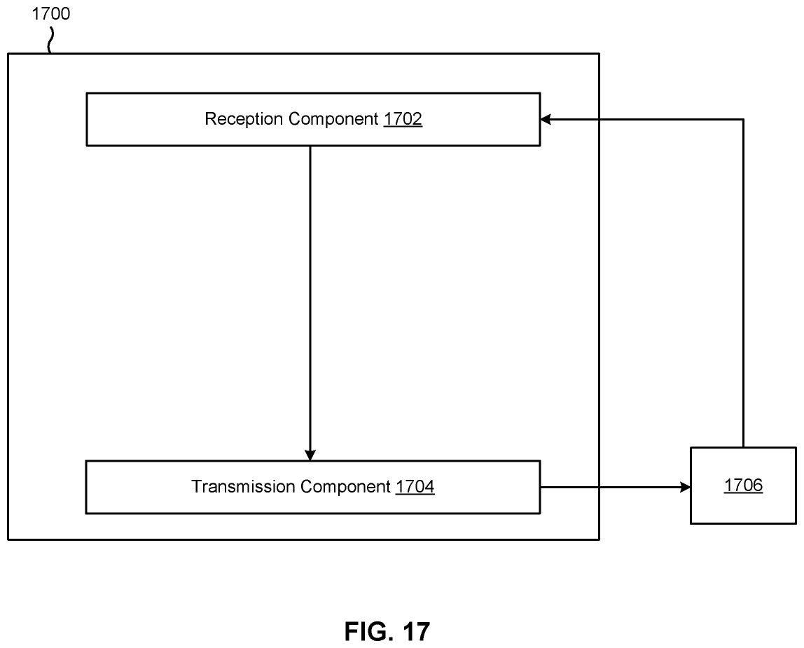

As shown in FIG. 15, in some aspects, process 1500 may include transmitting, to a second UE, an S-PSS using two S-PSS symbols in an S-SSB slot, the S-SSB slot being associated with an SL-U S-SSB pattern for data multiplexing, and the S-SSB slot being associated with a wideband PSBCH (block 1510). For example, the first UE (e.g., using transmission component 1704, depicted in FIG. 17) may transmit, to a second UE, an S-PSS using two S-PSS symbols in an S-SSB slot, the S-SSB slot being associated with an SL-U S-SSB pattern for data multiplexing, and the S-SSB slot being associated with a wideband PSBCH, as described above.

As further shown in FIG. 15, in some aspects, process 1500 may include transmitting, to the second UE, an S-SSS using two S-SSS symbols in the S-SSB slot, the S-SSB slot including four contiguous symbols that include the two S-PSS symbols and the two S-SSS symbols (block 1520). For example, the first UE (e.g., using transmission component 1704, depicted in FIG. 17) may transmit, to the second UE, an S-SSS using two S-SSS symbols in the S-SSB slot, the S-SSB slot including four contiguous symbols that include the two S-PSS symbols and the two S-SSS symbols, as described above.

Process 1500 may include additional aspects, such as any single aspect or any combination of aspects described below and/or in connection with one or more other processes described elsewhere herein.

In a first aspect, the four contiguous symbols do not overlap in a time domain and a frequency domain with a first four symbols of the S-SSB slot, based at least in part on the SL-U S-SSB pattern for data multiplexing.

In a second aspect, alone or in combination with the first aspect, the four contiguous symbols do not overlap in a time domain and a frequency domain with a PSCCH of the S-SSB slot, based at least in part on the SL-U S-SSB pattern for data multiplexing.

In a third aspect, alone or in combination with one or more of the first and second aspects, the four contiguous symbols do not overlap in a time domain and a frequency domain with DMRS symbols associated with a PSSCH of the S-SSB slot, based at least in part on the SL-U S-SSB pattern for data multiplexing.

In a fourth aspect, alone or in combination with one or more of the first through third aspects, the four contiguous symbols do not overlap in a time domain and a frequency with SCI-2, based at least in part on the SL-U S-SSB pattern for data multiplexing.

In a fifth aspect, alone or in combination with one or more of the first through fourth aspects, the S-SSB slot is associated with a DMRS pattern having a four-symbol gap, a five-symbol gap, or a six-symbol gap between DMRSs to enable the four contiguous symbols to fit within the S-SSB slot.

In a sixth aspect, alone or in combination with one or more of the first through fifth aspects, the wideband PSBCH is an interlaced PSBCH across the S-SSB slot and rate matched around the two S-PSS symbols and the two S-SSS symbols.

In a seventh aspect, alone or in combination with one or more of the first through sixth aspects, the wideband PSBCH is a four-symbol interlaced PSBCH that is frequency division multiplexed with the two S-PSS symbols and the two S-SSS symbols, wherein PSBCH interlaced RBs are punctured or rate matched around S-PSS RBs and S-SSS RBs, and the PSBCH interlaced RBs are at least a defined quantity of RBs from the S-PSS RBs and the S-SSS RBs.

In an eighth aspect, alone or in combination with one or more of the first through seventh aspects, the wideband PSBCH is an interlaced PSBCH across the S-SSB slot and rate matched around S-PSS REs and S-SSS REs, wherein PSBCH interlaced RBs are punctured or rate matched around S-PSS RBs and S-SSS RBs, and the PSBCH interlaced RBs are at least a defined quantity of RBs from the S-PSS RBs and the S-SSS RBs.

In a ninth aspect, alone or in combination with one or more of the first through eighth aspects, the wideband PSBCH is a contiguous wideband four-symbol PSBCH that is frequency division multiplexed with the two S-PSS symbols and the two S-SSS symbols.

In a tenth aspect, alone or in combination with one or more of the first through ninth aspects, data associated with another UE is multiplexed in the S-SSB slot based at least in part on a PSBCH interface that is not used for a PSCCH or PSSCH transmission across the S-SSB slot, or based at least in part on a time division multiplexing.

In an eleventh aspect, alone or in combination with one or more of the first through tenth aspects, a padding S-PSS or S-SSS with reserved sequences is transmitted, an S-SSB transmission is repeated, or the S-SSB transmission is triggered to be repeated in the S-SSB slot within a COT to maintain a COT transmission across the four contiguous symbols in the S-SSB slot.

In a twelfth aspect, alone or in combination with one or more of the first through eleventh aspects, the wideband PSBCH is transmitted based at least in part on a fixed PSBCH interlace.

In a thirteenth aspect, alone or in combination with one or more of the first through twelfth aspects, the wideband PSBCH is transmitted based at least in part on a PSBCH interlace index, and the PSBCH interlace index is a function of a sidelink synchronization signal identifier.

Although FIG. 15 shows example blocks of process 1500, in some aspects, process 1500 may include additional blocks, fewer blocks, different blocks, or differently arranged blocks than those depicted in FIG. 15. Additionally, or alternatively, two or more of the blocks of process 1500 may be performed in parallel.

FIG. 16 is a diagram illustrating an example process 1600 performed, for example, by a second UE, in accordance with the present disclosure. Example process 1600 is an example where the second UE (e.g., second UE 120e) performs operations associated with an SL-U S-SSB pattern for data multiplexing.

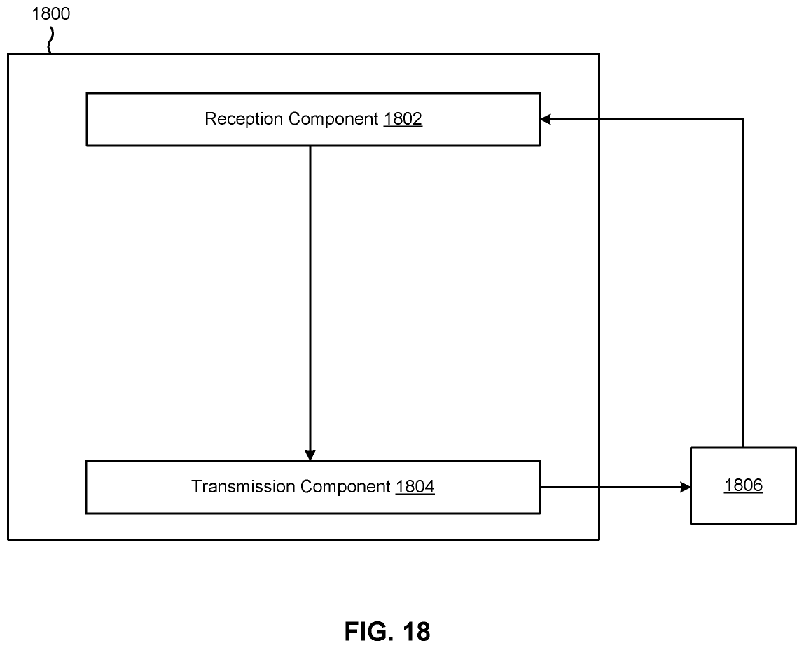

As shown in FIG. 16, in some aspects, process 1600 may include receiving, from a first UE, an S-PSS using two S-PSS symbols in an S-SSB slot, the S-SSB slot being associated with an SL-U S-SSB pattern for data multiplexing, and the S-SSB slot being associated with a wideband PSBCH (block 1610). For example, the second UE (e.g., using reception component 1802, depicted in FIG. 18) may receive, from a first UE, an S-PSS using two S-PSS symbols in an S-SSB slot, the S-SSB slot being associated with an SL-U S-SSB pattern for data multiplexing, and the S-SSB slot being associated with a wideband PSBCH, as described above.

As further shown in FIG. 16, in some aspects, process 1600 may include receiving, from the first UE, an S-SSS using two S-SSS symbols in the S-SSB slot, the S-SSB slot including four contiguous symbols that include the two S-PSS symbols and the two S-SSS symbols (block 1620). For example, the second UE (e.g., using reception component 1802, depicted in FIG. 18) may receive, from the first UE, an S-SSS using two S-SSS symbols in the S-SSB slot, the S-SSB slot including four contiguous symbols that include the two S-PSS symbols and the two S-SSS symbols, as described above.

In a first aspect, the four contiguous symbols do not overlap in a time domain and a frequency domain with a first four symbols of the S-SSB slot, based at least in part on the SL-U S-SSB pattern for data multiplexing.

In a second aspect, alone or in combination with the first aspect, the four contiguous symbols do not overlap in a time domain and a frequency domain with a PSCCH of the S-SSB slot, based at least in part on the SL-U S-SSB pattern for data multiplexing.

In a third aspect, alone or in combination with one or more of the first and second aspects, the four contiguous symbols do not overlap in a time domain and a frequency domain with DMRS symbols associated with a PSSCH of the S-SSB slot, based at least in part on the SL-U S-SSB pattern for data multiplexing.

In a fourth aspect, alone or in combination with one or more of the first through third aspects, the four contiguous symbols do not overlap in a time domain and a frequency with SCI-2, based at least in part on the SL-U S-SSB pattern for data multiplexing.

In a fifth aspect, alone or in combination with one or more of the first through fourth aspects, the S-SSB slot is associated with a DMRS pattern having a four-symbol gap, a five-symbol gap, or a six-symbol gap between DMRSs to enable the four contiguous symbols to fit within the S-SSB slot.

In a sixth aspect, alone or in combination with one or more of the first through fifth aspects, the wideband PSBCH is an interlaced PSBCH across the S-SSB slot and rate matched around the two S-PSS symbols and the two S-SSS symbols.

In a seventh aspect, alone or in combination with one or more of the first through sixth aspects, the wideband PSBCH is a four-symbol interlaced PSBCH that is frequency division multiplexed with the two S-PSS symbols and the two S-SSS symbols, wherein PSBCH interlaced RBs are punctured or rate matched around S-PSS RBs and S-SSS RBs, and the PSBCH interlaced RBs are at least a defined quantity of RBs from the S-PSS RBs and the S-SSS RBs.

In an eighth aspect, alone or in combination with one or more of the first through seventh aspects, the wideband PSBCH is an interlaced PSBCH across the S-SSB slot and rate matched around S-PSS REs and S-SSS REs, wherein PSBCH interlaced RBs are punctured or rate matched around S-PSS RBs and S-SSS RBs, and the PSBCH interlaced RBs are at least a defined quantity of RBs from the S-PSS RBs and the S-SSS RBs.

In a ninth aspect, alone or in combination with one or more of the first through eighth aspects, the wideband PSBCH is a contiguous wideband four-symbol PSBCH that is frequency division multiplexed with the two S-PSS symbols and the two S-SSS symbols.

In a tenth aspect, alone or in combination with one or more of the first through ninth aspects, data associated with another UE is multiplexed in the S-SSB slot based at least in part on a PSBCH interface that is not used for a PSCCH or PSSCH transmission across the S-SSB slot, or based at least in part on a time division multiplexing.

In an eleventh aspect, alone or in combination with one or more of the first through tenth aspects, a padding S-PSS or S-SSS with reserved sequences is transmitted, an S-SSB transmission is repeated, or the S-SSB transmission is triggered to be repeated in the S-SSB slot within a COT to maintain a COT transmission across the four contiguous symbols in the S-SSB slot.

In a twelfth aspect, alone or in combination with one or more of the first through eleventh aspects, the wideband PSBCH is received based at least in part on a fixed PSBCH interlace.

In a thirteenth aspect, alone or in combination with one or more of the first through twelfth aspects, the wideband PSBCH is received based at least in part on a PSBCH interlace index, and the PSBCH interlace index is a function of a sidelink synchronization signal identifier.

Process 1600 may include additional aspects, such as any single aspect or any combination of aspects described below and/or in connection with one or more other processes described elsewhere herein.

Although FIG. 16 shows example blocks of process 1600, in some aspects, process 1600 may include additional blocks, fewer blocks, different blocks, or differently arranged blocks than those depicted in FIG. 16. Additionally, or alternatively, two or more of the blocks of process 1600 may be performed in parallel.

FIG. 17 is a diagram of an example apparatus 1700 for wireless communication, in accordance with the present disclosure. The apparatus 1700 may be a first UE, or a first UE may include the apparatus 1700. In some aspects, the apparatus 1700 includes a reception component 1702 and a transmission component 1704, which may be in communication with one another (for example, via one or more buses and/or one or more other components). As shown, the apparatus 1700 may communicate with another apparatus 1706 (such as a UE, a base station, or another wireless communication device) using the reception component 1702 and the transmission component 1704.

In some aspects, the apparatus 1700 may be configured to perform one or more operations described herein in connection with FIGS. 8-14. Additionally, or alternatively, the apparatus 1700 may be configured to perform one or more processes described herein, such as process 1500 of FIG. 15. In some aspects, the apparatus 1700 and/or one or more components shown in FIG. 17 may include one or more components of the first UE described in connection with FIG. 2. Additionally, or alternatively, one or more components shown in FIG. 17 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1702 may receive communications, such as reference signals, control information, data communications, or a combination thereof, from the apparatus 1706. The reception component 1702 may provide received communications to one or more other components of the apparatus 1700. In some aspects, the reception component 1702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1700. In some aspects, the reception component 1702 may include one or more antennas, a modem, a demodulator, a MIMO detector, a receive processor, a controller/processor, a memory, or a combination thereof, of the first UE described in connection with FIG. 2.

The transmission component 1704 may transmit communications, such as reference signals, control information, data communications, or a combination thereof, to the apparatus 1706. In some aspects, one or more other components of the apparatus 1700 may generate communications and may provide the generated communications to the transmission component 1704 for transmission to the apparatus 1706. In some aspects, the transmission component 1704 may perform signal processing on the generated communications (such as filtering, amplification, modulation, digital-to-analog conversion, multiplexing, interleaving, mapping, or encoding, among other examples), and may transmit the processed signals to the apparatus 1706. In some aspects, the transmission component 1704 may include one or more antennas, a modem, a modulator, a transmit MIMO processor, a transmit processor, a controller/processor, a memory, or a combination thereof, of the first UE described in connection with FIG. 2. In some aspects, the transmission component 1704 may be co-located with the reception component 1702 in a transceiver.

The transmission component 1704 may transmit, to a second UE, an S-PSS using two S-PSS symbols in an S-SSB slot, the S-SSB slot being associated with an SL-U S-SSB pattern for data multiplexing, and the S-SSB slot being associated with a wideband PSBCH. The transmission component 1704 may transmit, to the second UE, an S-SSS using two S-SSS symbols in the S-SSB slot, the S-SSB slot including four contiguous symbols that include the two S-PSS symbols and the two S-SSS symbols.

The number and arrangement of components shown in FIG. 17 are provided as an example. In practice, there may be additional components, fewer components, different components, or differently arranged components than those shown in FIG. 17. Furthermore, two or more components shown in FIG. 17 may be implemented within a single component, or a single component shown in FIG. 17 may be implemented as multiple, distributed components. Additionally, or alternatively, a set of (one or more) components shown in FIG. 17 may perform one or more functions described as being performed by another set of components shown in FIG. 17.

FIG. 18 is a diagram of an example apparatus 1800 for wireless communication, in accordance with the present disclosure. The apparatus 1800 may be a second UE, or a second UE may include the apparatus 1800. In some aspects, the apparatus 1800 includes a reception component 1802 and a transmission component 1804, which may be in communication with one another (for example, via one or more buses and/or one or more other components). As shown, the apparatus 1800 may communicate with another apparatus 1806 (such as a UE, a base station, or another wireless communication device) using the reception component 1802 and the transmission component 1804.

In some aspects, the apparatus 1800 may be configured to perform one or more operations described herein in connection with FIGS. 8-14. Additionally, or alternatively, the apparatus 1800 may be configured to perform one or more processes described herein, such as process 1600 of FIG. 16. In some aspects, the apparatus 1800 and/or one or more components shown in FIG. 18 may include one or more components of the second UE described in connection with FIG. 2. Additionally, or alternatively, one or more components shown in FIG. 18 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1802 may receive communications, such as reference signals, control information, data communications, or a combination thereof, from the apparatus 1806. The reception component 1802 may provide received communications to one or more other components of the apparatus 1800. In some aspects, the reception component 1802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1800. In some aspects, the reception component 1802 may include one or more antennas, a modem, a demodulator, a MIMO detector, a receive processor, a controller/processor, a memory, or a combination thereof, of the second UE described in connection with FIG. 2.

The transmission component 1804 may transmit communications, such as reference signals, control information, data communications, or a combination thereof, to the apparatus 1806. In some aspects, one or more other components of the apparatus 1800 may generate communications and may provide the generated communications to the transmission component 1804 for transmission to the apparatus 1806. In some aspects, the transmission component 1804 may perform signal processing on the generated communications (such as filtering, amplification, modulation, digital-to-analog conversion, multiplexing, interleaving, mapping, or encoding, among other examples), and may transmit the processed signals to the apparatus 1806. In some aspects, the transmission component 1804 may include one or more antennas, a modem, a modulator, a transmit MIMO processor, a transmit processor, a controller/processor, a memory, or a combination thereof, of the second UE described in connection with FIG. 2. In some aspects, the transmission component 1804 may be co-located with the reception component 1802 in a transceiver.

The reception component 1802 may receive, from a first UE, an S-PSS using two S-PSS symbols in an S-SSB slot, the S-SSB slot being associated with an SL-U S-SSB pattern for data multiplexing, and the S-SSB slot being associated with a wideband PSBCH. The reception component 1802 may receive, from the first UE, an S-SSS using two S-SSS symbols in the S-SSB slot, the S-SSB slot including four contiguous symbols that include the two S-PSS symbols and the two S-SSS symbols.

The number and arrangement of components shown in FIG. 18 are provided as an example. In practice, there may be additional components, fewer components, different components, or differently arranged components than those shown in FIG. 18. Furthermore, two or more components shown in FIG. 18 may be implemented within a single component, or a single component shown in FIG. 18 may be implemented as multiple, distributed components. Additionally, or alternatively, a set of (one or more) components shown in FIG. 18 may perform one or more functions described as being performed by another set of components shown in FIG. 18.

The following provides an overview of some Aspects of the present disclosure:

Aspect 1: A method of wireless communication performed by an apparatus of a first user equipment (UE), comprising: transmitting, to a second UE, a sidelink primary synchronization signal (S-PSS) using two S-PSS symbols in a sidelink synchronization signal block (S-SSB) slot, the S-SSB slot being associated with a sidelink unlicensed (SL-U) S-SSB pattern for data multiplexing, and the S-SSB slot being associated with a wideband physical sidelink broadcast channel (PSBCH); and transmitting, to the second UE, a sidelink secondary synchronization signal (S-SSS) using two S-SSS symbols in the S-SSB slot, the S-SSB slot including four contiguous symbols that include the two S-PSS symbols and the two S-SSS symbols.

Aspect 2: The method of Aspect 1, wherein the four contiguous symbols do not overlap in a time domain and a frequency domain with a first four symbols of the S-SSB slot, based at least in part on the SL-U S-SSB pattern for data multiplexing.

Aspect 3: The method of any of Aspects 1-2, wherein the four contiguous symbols do not overlap in a time domain and a frequency domain with a physical sidelink control channel of the S-SSB slot, based at least in part on the SL-U S-SSB pattern for data multiplexing.

Aspect 4: The method of any of Aspects 1-3, wherein the four contiguous symbols do not overlap in a time domain and a frequency domain with demodulation reference signal symbols associated with a physical sidelink shared channel of the S-SSB slot, based at least in part on the SL-U S-SSB pattern for data multiplexing.

Aspect 5: The method of any of Aspects 1-4, wherein the four contiguous symbols do not overlap in a time domain and a frequency with sidelink control information part 2, based at least in part on the SL-U S-SSB pattern for data multiplexing.

Aspect 6: The method of any of Aspects 1-5, wherein the S-SSB slot is associated with a demodulation reference signal (DMRS) pattern having a four-symbol gap, a five-symbol gap, or a six-symbol gap between DMRSs to enable the four contiguous symbols to fit within the S-SSB slot.

Aspect 7: The method of any of Aspects 1-6, wherein the wideband PSBCH is an interlaced PSBCH across the S-SSB slot and rate matched around the two S-PSS symbols and the two S-SSS symbols.

Aspect 8: The method of any of Aspects 1-7, wherein the wideband PSBCH is a four-symbol interlaced PSBCH that is frequency division multiplexed with the two S-PSS symbols and the two S-SSS symbols, wherein PSBCH interlaced resource blocks (RBs) are punctured or rate matched around S-PSS RBs and S-SSS RBs, and wherein the PSBCH interlaced RBs are at least a defined quantity of RBs from the S-PSS RBs and the S-SSS RBs.

Aspect 9: The method of any of Aspects 1-8, wherein the wideband PSBCH is an interlaced PSBCH across the S-SSB slot and rate matched around S-PSS resource elements (REs) and S-SSS REs, wherein PSBCH interlaced resource blocks (RBs) are punctured or rate matched around S-PSS RBs and S-SSS RBs, and wherein the PSBCH interlaced RBs are at least a defined quantity of RBs from the S-PSS RBs and the S-SSS RBs.

Aspect 10: The method of any of Aspects 1-9, wherein the wideband PSBCH is a contiguous wideband four-symbol PSBCH that is frequency division multiplexed with the two S-PSS symbols and the two S-SSS symbols.

Aspect 11: The method of any of Aspects 1-10, wherein data associated with another UE is multiplexed in the S-SSB slot based at least in part on a PSBCH interface that is not used for a physical sidelink control channel or physical sidelink shared channel transmission across the S-SSB slot, or based at least in part on a time division multiplexing.

Aspect 12: The method of any of Aspects 1-11, wherein a padding S-PSS or S-SSS with reserved sequences is transmitted, an S-SSB transmission is repeated, or the S-SSB transmission is triggered to be repeated in the S-SSB slot within a channel occupancy time (COT) to maintain a COT transmission across the four contiguous symbols in the S-SSB slot.

Aspect 13: The method of any of Aspects 1-12, wherein the wideband PSBCH is transmitted based at least in part on a fixed PSBCH interlace.

Aspect 14: The method of any of Aspects 1-13, wherein the wideband PSBCH is transmitted based at least in part on a PSBCH interlace index, and wherein the PSBCH interlace index is a function of a sidelink synchronization signal identifier.

Aspect 15: A method of wireless communication performed by an apparatus of a second user equipment (UE), comprising: receiving, from a first UE, a sidelink primary synchronization signal (S-PSS) using two S-PSS symbols in a sidelink synchronization signal block (S-SSB) slot, the S-SSB slot being associated with a sidelink unlicensed (SL-U) S-SSB pattern for data multiplexing, and the S-SSB slot being associated with a wideband physical sidelink broadcast channel (PSBCH); and receiving, from the first UE, a sidelink secondary synchronization signal (S-SSS) using two S-SSS symbols in the S-SSB slot, the S-SSB slot including four contiguous symbols that include the two S-PSS symbols and the two S-SSS symbols.

Aspect 16: An apparatus for wireless communication at a device, comprising a processor; memory coupled with the processor; and instructions stored in the memory and executable by the processor to cause the apparatus to perform the method of one or more of Aspects 1-14.

Aspect 17: A device for wireless communication, comprising a memory and one or more processors coupled to the memory, the one or more processors configured to perform the method of one or more of Aspects 1-14.

Aspect 18: An apparatus for wireless communication, comprising at least one means for performing the method of one or more of Aspects 1-14.

Aspect 19: A non-transitory computer-readable medium storing code for wireless communication, the code comprising instructions executable by a processor to perform the method of one or more of Aspects 1-14.

Aspect 20: A non-transitory computer-readable medium storing a set of instructions for wireless communication, the set of instructions comprising one or more instructions that, when executed by one or more processors of a device, cause the device to perform the method of one or more of Aspects 1-14.

Aspect 21: An apparatus for wireless communication at a device, comprising a processor; memory coupled with the processor; and instructions stored in the memory and executable by the processor to cause the apparatus to perform the method of Aspect 15.

Aspect 22: A device for wireless communication, comprising a memory and one or more processors coupled to the memory, the one or more processors configured to perform the method of Aspect 15.

Aspect 23: An apparatus for wireless communication, comprising at least one means for performing the method of Aspect 15.

Aspect 24: A non-transitory computer-readable medium storing code for wireless communication, the code comprising instructions executable by a processor to perform the method of Aspect 15.

Aspect 25: A non-transitory computer-readable medium storing a set of instructions for wireless communication, the set of instructions comprising one or more instructions that, when executed by one or more processors of a device, cause the device to perform the method of Aspect 15.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. An apparatus for wireless communications at a first user equipment (UE), comprising:
a processor;
memory coupled with the processor; and
instructions stored in the memory and executable by the processor to cause the apparatus to:
transmit, to a second UE, a sidelink primary synchronization signal (S-PSS) using two S-PSS symbols in a sidelink synchronization signal block (S-SSB) slot, the S-SSB slot being associated with a sidelink unlicensed (SL-U) S-SSB pattern for data multiplexing, and the S-SSB slot being associated with a wideband physical sidelink broadcast channel (PSBCH); and
transmit, to the second UE, a sidelink secondary synchronization signal (S-SSS) using two S-SSS symbols in the S-SSB slot, the S-SSB slot including four contiguous symbols that include the two S-PSS symbols and the two S-SSS symbols.

2. The apparatus of claim 1, wherein the four contiguous symbols do not overlap in a time domain and a frequency domain with a first four symbols of the S-SSB slot, based at least in part on the SL-U S-SSB pattern for data multiplexing.

3. The apparatus of claim 1, wherein the four contiguous symbols do not overlap in a time domain and a frequency domain with a physical sidelink control channel of the S-SSB slot, based at least in part on the SL-U S-SSB pattern for data multiplexing.

4. The apparatus of claim 1, wherein the four contiguous symbols do not overlap in a time domain and a frequency domain with demodulation reference signal symbols associated with a physical sidelink shared channel of the S-SSB slot, based at least in part on the SL-U S-SSB pattern for data multiplexing.

5. The apparatus of claim 1, wherein the four contiguous symbols do not overlap in a time domain and a frequency with sidelink control information part 2, based at least in part on the SL-U S-SSB pattern for data multiplexing.

6. The apparatus of claim 1, wherein the S-SSB slot is associated with a demodulation reference signal (DMRS) pattern having a four-symbol gap, a five-symbol gap, or a six-symbol gap between DMRSs to enable the four contiguous symbols to fit within the S-SSB slot.

7. The apparatus of claim 1, wherein the wideband PSBCH is an interlaced PSBCH across the S-SSB slot and rate matched around the two S-PSS symbols and the two S-SSS symbols.

8. The apparatus of claim 1, wherein the wideband PSBCH is a four-symbol interlaced PSBCH that is frequency division multiplexed with the two S-PSS symbols and the two S-SSS symbols, wherein PSBCH interlaced resource blocks (RBs) are punctured or rate matched around S-PSS RBs and S-SSS RBs, and wherein the PSBCH interlaced RBs are at least a defined quantity of RBs from the S-PSS RBs and the S-SSS RBs.

9. The apparatus of claim 1, wherein the wideband PSBCH is an interlaced PSBCH across the S-SSB slot and rate matched around S-PSS resource elements (REs) and S-SSS REs, wherein PSBCH interlaced resource blocks (RBs) are punctured or rate matched around S-PSS RBs and S-SSS RBs, and wherein the PSBCH interlaced RBs are at least a defined quantity of RBs from the S-PSS RBs and the S-SSS RBs.

10. The apparatus of claim 1, wherein the wideband PSBCH is a contiguous wideband four-symbol PSBCH that is frequency division multiplexed with the two S-PSS symbols and the two S-SSS symbols.

11. The apparatus of claim 1, wherein data associated with another UE is multiplexed in the S-SSB slot based at least in part on a PSBCH interface that is not used for a physical sidelink control channel or physical sidelink shared channel transmission across the S-SSB slot, or based at least in part on a time division multiplexing.

12. The apparatus of claim 1, wherein a padding S-PSS or S-SSS with reserved sequences is transmitted, an S-SSB transmission is repeated, or the S-SSB transmission is triggered to be repeated in the S-SSB slot within a channel occupancy time (COT) to maintain a COT transmission across the four contiguous symbols in the S-SSB slot.

13. The apparatus of claim 1, wherein the wideband PSBCH is transmitted based at least in part on a fixed PSBCH interlace.

14. The apparatus of claim 1, wherein the wideband PSBCH is transmitted based at least in part on a PSBCH interlace index, and wherein the PSBCH interlace index is a function of a sidelink synchronization signal identifier.

15. An apparatus for wireless communications at a second user equipment (UE), comprising:
a processor;
memory coupled with the processor; and
instructions stored in the memory and executable by the processor to cause the apparatus to:
receive, from a first UE, a sidelink primary synchronization signal (S-PSS) using two S-PSS symbols in a sidelink synchronization signal block (S-SSB) slot, the S-SSB slot being associated with a sidelink unlicensed (SL-U) S-SSB pattern for data multiplexing, and the S-SSB slot being associated with a wideband physical sidelink broadcast channel (PSBCH); and
receive, from the first UE, a sidelink secondary synchronization signal (S-SSS) using two S-SSS symbols in the S-SSB slot, the S-SSB slot including four contiguous symbols that include the two S-PSS symbols and the two S-SSS symbols.

16. A method of wireless communication performed by an apparatus of a first user equipment (UE), comprising:
transmitting, to a second UE, a sidelink primary synchronization signal (S-PSS) using two S-PSS symbols in a sidelink synchronization signal block (S-SSB) slot, the S-SSB slot being associated with a sidelink unlicensed (SL-U) S-SSB pattern for data multiplexing, and the S-SSB slot being associated with a wideband physical sidelink broadcast channel (PSBCH); and transmitting, to the second UE, a sidelink secondary synchronization signal (S-SSS) using two S-SSS symbols in the S-SSB slot, the S-SSB slot including four contiguous symbols that include the two S-PSS symbols and the two S-SSS symbols.

17. The method of claim 16, wherein the four contiguous symbols do not overlap in a time domain and a frequency domain with a first four symbols of the S-SSB slot, based at least in part on the SL-U S-SSB pattern for data multiplexing.

18. The method of claim 16, wherein the four contiguous symbols do not overlap in a time domain and a frequency domain with a physical sidelink control channel of the S-SSB slot, based at least in part on the SL-U S-SSB pattern for data multiplexing.

19. The method of claim 16, wherein the four contiguous symbols do not overlap in a time domain and a frequency domain with demodulation reference signal symbols associated with a physical sidelink shared channel of the S-SSB slot, based at least in part on the SL-U S-SSB pattern for data multiplexing.

20. The method of claim 16, wherein the four contiguous symbols do not overlap in a time domain and a frequency with sidelink control information part 2, based at least in part on the SL-U S-SSB pattern for data multiplexing.

21-30. (canceled)
